(19) United States
(12) Patent Application Publication
(10) Pub. No.: US 2016/0168883 A1
(43) Pub. Date: Jun. 16, 2016

(54) DOUBLE PULL ACTION VEHICLE HOOD LATCH

(71) Applicant: GM Global Technology Operations LLC, Detroit, MI (US)

(72) Inventor: JEFFREY L. KONCHAN, Romeo, MI (US)

(21) Appl. No.: 14/570,287

(22) Filed: Dec. 15, 2014

(51) Int. Cl. E05B 83/24

(52) U.S. Cl. CPC E05B 83/24

(57) ABSTRACT

A product is disclosed for latching a closure having a striker. A fork bolt may engage the striker. Primary and secondary detent levers may be positioned for selective engagement with the fork bolt. The primary detent lever may engage and retain the fork bolt in a primary latched position. Upon a first rotation, the primary detent lever may disengage the fork bolt which rotates to a secondary latched position and into retaining engagement with the secondary detent lever. Upon a second rotation, the primary detent lever may interact with the secondary detent lever to rotate it to the disengaged position and disengage it from the fork bolt which then rotates to the open position.

### TECHNICAL FIELD

The field to which the disclosure generally relates includes latches and more particularly, includes vehicle hood latches.

### BACKGROUND

An automobile's hood typically includes a latch assembly with a primary latch for latching the hood in its closed position. A cable release operable from inside the vehicle may be provided to move the primary latch to an unlatched position. A spring may be provided to move the hood to a partly open position where the hood is held by a secondary latch. The secondary latch may be provided to ensure release of the primary latch alone will not fully open the hood. The secondary latch is typically manually operated and accessed at the front of the vehicle. Fully opening a hood requires release of the primary latch from inside the vehicle and release of the secondary latch from the front outside of the vehicle.

### SUMMARY OF ILLUSTRATIVE VARIATIONS

A product for latching a closure may be provided according to a number of variations where a striker may be connected to the closure. A fork bolt may be configured to rotate between a primary latched position, a secondary latched position and an open position. The fork bolt may be disposed relative to the striker such that it engages the striker in the primary latched position and in the secondary latched position. A primary detent lever may be positioned for selective engagement with the fork bolt and may be configured to rotate between a detent latched position, a secondary detent position, and a detent release position. A secondary detent lever may be positioned for selective engagement with the fork bolt and may be interactively coupled to the primary detent lever. The secondary detent lever may be configured to rotate between an engaged position and a disengaged position. The primary detent lever in the detent latched position may engage and retain the fork bolt in the primary latched position. Upon a first rotation of the primary detent lever to the secondary detent position the primary detent lever may disengage the fork bolt which rotates to the secondary latched position and into retaining engagement with the secondary detent lever. Upon a second rotation of the primary detent lever to the detent release position, the primary detent lever may interact with the secondary detent lever to rotate it to the disengaged position and disengage it from the fork bolt which then rotates to the open position.

According to a number of other variations a latch may have a plate with a fork bolt rotatably mounted on the plate in a first plane. A primary detent lever may be rotatably mounted on the plate so that it may be disposed in the first plane. The primary detent lever may selectively engage the fork bolt and may be configured to hold the fork bolt in a primary latched position. A secondary detent lever may have an offset section with a leg on one side of the offset section disposed in a second plane and an arm on a second side of the offset section disposed in the first plane. The secondary detent lever may be configured to engage the fork bolt and hold it in a secondary latched position.

According to a number of other variations a latch may be provided for releasing the striker of a closure after two successive pulls of a cable. The latch may include a fork bolt, a primary detent lever and a secondary detent lever. The fork bolt may be held in a primary latched position by the primary detent lever and the fork bolt may be held in the secondary latched position by the secondary detent lever. The fork bolt may be configured to hold the striker in a primary latched position and to release the striker from the primary latched position to a secondary latched position upon a first pull of the cable. The fork bolt may be configured to release the striker from the secondary latched position to an open position upon a second pull on the cable when the second pull is preceded by a release of the cable following the first pull on the cable.

Other illustrative variations within the scope of the invention will become apparent from the detailed description provided herein. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a schematic illustration of a hood latch in a closed, primary latched position according to a number of variations.

FIG. 2 is a schematic illustration of a hood latch in a closed, primary latched position according to a number of variations.

FIG. 3 is a schematic illustration of a hood latch in a primary unlatched-secondary latched position according to a number of variations.

FIG. 4 is a schematic illustration of a hood latch in a primary unlatched-secondary latched position according to a number of variations.

FIG. 5 is a schematic illustration of a hood latch in an open, secondary unlatched position according to a number of variations.

FIG. 6 is a schematic illustration of a hood latch in a released, open position according to a number of variations.

### DETAILED DESCRIPTION OF ILLUSTRATIVE VARIATIONS

The following description of the variations is merely illustrative in nature and is in no way intended to limit the scope of the invention, its application, or uses.

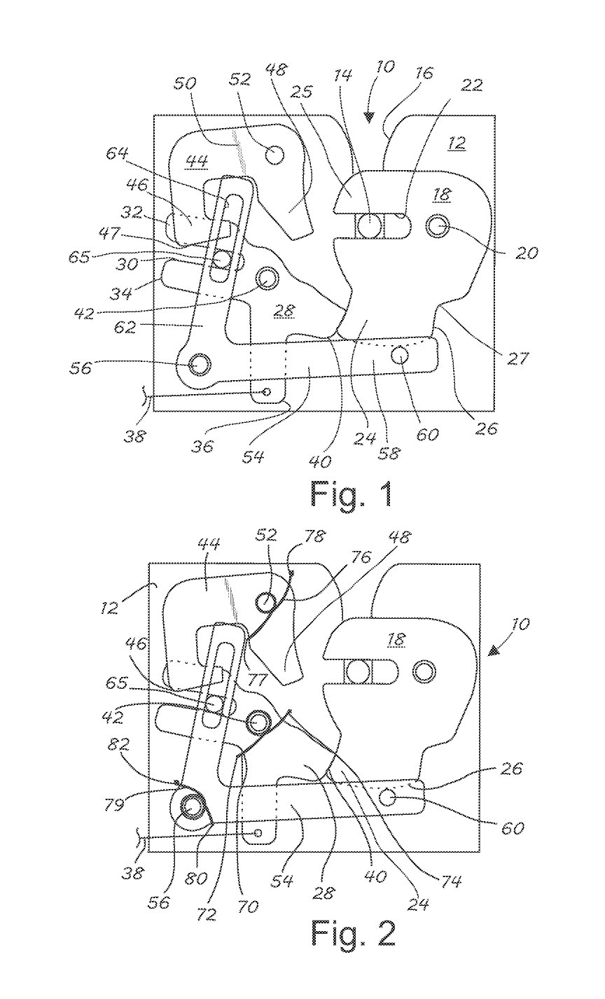

Referring to FIG. 1 an assembly 10 for latching a closure such as a vehicle's hood according to a number of variations is illustrated. Latch 10 includes a backing plate 12 upon which latch components may be mounted. The latch 10 interacts with a striker 14 which may be attached to the hood (not illustrated), of an automobile. The striker 14 enters a slot 16 and cooperates with a bolt referred to as a fork bolt 18. Positions of the striker 14 may be described corresponding to positions of the fork bolt 18. The fork bolt 18 includes a body that pivots about a post 20 and has a slot 22, a foot 24, an arm 25, and a cam surface 26 with a detent 27. The latch 10 includes a primary detent lever 28 which has a body with an opening designated as a slot 30 between the arms 32 and 34, a lever 36 which may be attached to a hood release cable 38, and a leg 40. The primary detent lever 28 may pivot about a post 42. The primary detent lever 28 may be positioned for selective engagement with the fork bolt 18 and may be configured to rotate between a detent latched position (shown in FIG. 1), a secondary detent position, and a detent release position. Latch 10 also includes a secondary detent lever 44 having a body having a foot 46 with a surface 47, and an arm 48 with an offset 50, and pivots about a post 52. The offset 50 may be formed as a bend in the body of the secondary detent lever 44 during a stamping or other forming operation so that the foot 46 and the arm 48 are not disposed in the same plane. The secondary detent lever may be positioned for selective engagement with the fork bolt 18, and for interactively coupling to the primary detent lever, and may be configured to rotate between an engaged position and a disengaged position. Latch 10 also includes a bolt follower lever referred to as a fork bolt follower lever 54, which includes a body pivoting about post 56 with a first arm 58 having a cam follower 60, and a second arm 62 having an enclosed slot 64. Positioned within the slot 30 of the primary detent lever 28 and the slot 64 of the fork bolt follower lever 54 is a power transfer stud 65. The fork bolt 18, the primary detent lever 28 and the arm 48 of secondary detent lever 44 lie in a common plane.

Referring to FIG. 2 the hood latch assembly of FIG. 1 is illustrated depicting springs which bias certain elements in a given direction according to a number of variations. More specifically, the primary detent lever 28 may include a spring 70 that wraps around a post 42 and includes a first end 72 and a second end 74. The end 72 may be wrapped around the edge of the primary detent lever 28, or may otherwise engage the primary detent lever 28 and the end 74 may be connected to the backing plate 12 (or otherwise grounded), so as to urge the primary detent lever 28 in a counterclockwise direction as illustrated. This may also be described as biasing the primary detent lever 28 to the position shown in FIG. 2 where the leg 40 is positioned against the foot 24 of the fork bolt 18, locking it in the fully closed, primary latched position. The secondary detent lever 44 may include a spring 76 that wraps around a post 52 and includes a first end 77 and a second end 78. The end 77 may be wrapped around the edge of the secondary detent lever 44, or may otherwise engage the secondary detent lever 44, and an end 78 may be connected to the backing plate 12 (or otherwise grounded), so as to urge secondary detent lever 44 in a counterclockwise direction as illustrated. This may also be described as biasing the secondary detent lever 44 to the position shown where the foot 46 is disengaged from the power transfer stud 65 and the arm 48 is disengaged from the fork bolt 18 so that the secondary detent lever 44 may be isolated in a stand-by mode. The fork bolt follower lever 54 may include a spring 79 that wraps around a post 56 and includes a first end 80 and a second end 82. The end 80 may be wrapped around the edge of the fork bolt follower lever 54, or may otherwise engage the fork bolt follower lever 54, and the end 82 may be connected to the backing plate 12 (or otherwise grounded), so as to urge the fork bolt follower lever 54 in a counterclockwise direction as illustrated. This may also be described as biasing the fork bolt follower lever 54 so that the cam follower 60 is biased against the cam surface 26 of the fork bolt 18. The primary detent lever 28 may be described as in a detent latched position. The springs 70, 76 and 79 are omitted from the schematic FIGS. 1 and 3-6 for simplicity of illustration but for functional purposes they may be included or may be replaced by other biasing devices.

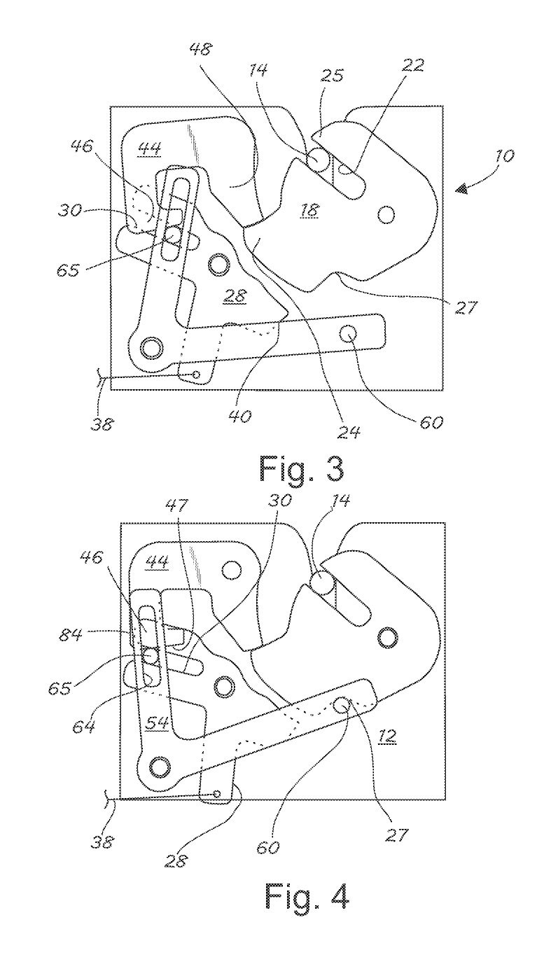

Referring to FIG. 3, the latch 10 has been repositioned to a secondary position according to a number of variations where the primary detent lever 28 has released the fork bolt 18, which is held in the secondary (primary released), position by the secondary detent lever 44, which is now in an engaged position. This may also be called the primary unlatched or secondary latched position. More specifically, a first pull on the hood release cable 38 rotated the primary detent lever 28 in the clockwise direction against the force of the spring 70 (shown in FIG. 2), to a secondary detent position, and has released the foot 24 of the fork bolt 18 from the leg 40 of the primary detent lever 28. The upward force applied by the striker 14 as a result of a hood opening spring (not shown), has rotated the fork bolt 18 when released from the primary detent lever 28. Rotation of the primary detent lever 28 has also brought the power transfer stud 65 positioned within the slot 30 into engagement with the foot 46 of the secondary detent lever 44. Release of the fork bolt 18 has allowed it to rotate to the point shown where the foot 24 contacts the arm 48 of the secondary detent lever 44. This locks the fork bolt 18 in the secondary latched position wherein the striker 14 has moved upward but is held in the slot 22 due to the vertical interference of the arm 25 which prevents full release of the latch 10.

When force is removed from the hood release cable 38 to a relaxed condition as shown in FIG. 4, the force of the spring 79, which may be assisted by the spring 70, (both shown in FIG. 2), causes the primary detent lever 28 and the fork bolt follower lever 54 to rotate counterclockwise until the cam follower 60 engages the fork bolt 18 in the detent 27. The power transfer stud 65 translates along the surface 47 of the foot 46 within the slot 30 of the primary detent lever 28 and the slot 64 of the fork bolt follower lever 54. This places the power transfer stud 65 to an active position shown wherein it has moved along the surface 47 to a position near the edge 84 of the secondary detent lever 44, wherein vertical force applied by the power transfer stud 65 will rotate the secondary detent lever 44 in a clockwise direction. If the cable 38 is not released to a relaxed condition, the primary detent lever 28 is not able to rotate the secondary detent lever 44.

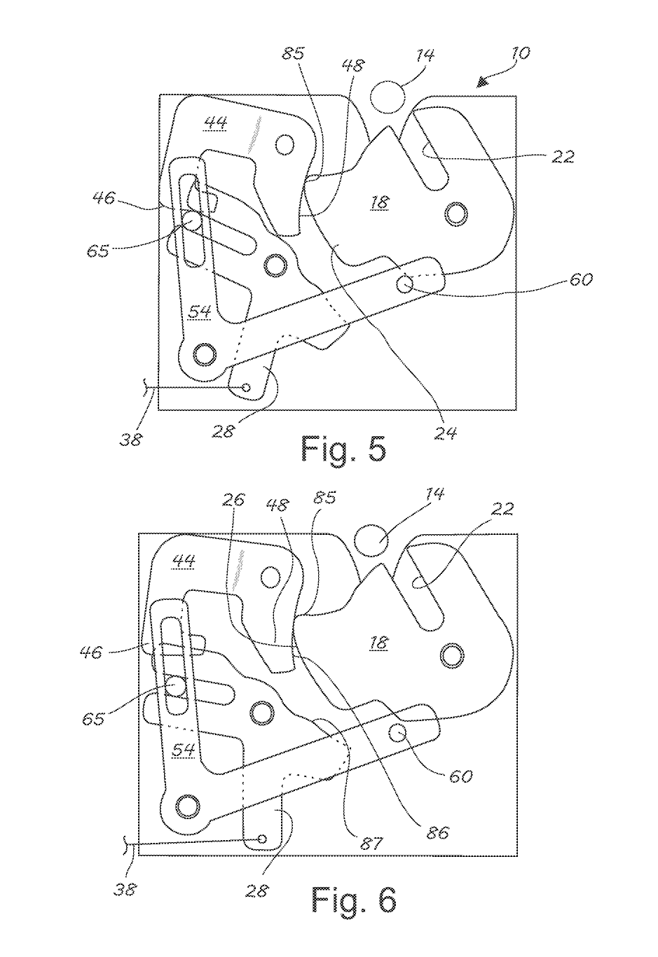

Referring to FIGS. 5 and 6, a number of variations are illustrated wherein the latch 10 may be in an open position and fully released and open. The primary detent lever 28 may be in a detent release position. A second application of force to the hood release cable 38 may be applied to cause the primary detent 28 to rotate in a clockwise direction applying force and interacting through the power transfer stud 65 to indirectly couple to the foot 46 as shown in FIG. 5, causing the secondary detent lever 44 to rotate in a clockwise direction. Rotation moves the arm 48 to slide past the end 85 of the foot 24 to a disengaged position, releasing the fork bolt 18 to rotate in a clockwise direction. This allows the force applied by the striker 14 to rotate the fork bolt 18 and be released from the slot 22 opening the hood and moving the latch 10 to the fully open condition. Release of the cable 38 allows the latch 10 to relax to the open position shown in FIG. 6 with secondary detent lever 44 holding fork bolt 18 in the open position. When the striker 14 may reenter the slot 22 upon closing of the hood, the cam surface 26 of the fork bolt 18 will slide downward along each of: the surface 86 of the secondary detent lever 44, the surface 87 of the primary detent 28, and along cam follower 60, resetting the latch 10 to the closed, primary latched position of FIG. 1.

The following description of variants is only illustrative of components, elements, acts, products and methods considered to be within the scope of the invention and is not in any way intended to limit such scope by what is specifically disclosed or not expressly set forth. Components, elements, acts, products and methods may be combined and rearranged other than as expressly described herein and still are considered to be within the scope of the invention.

Variation 1 may include a product for latching a closure. A striker may be connected to the closure. A fork bolt may be configured to rotate between a primary latched position, a secondary latched position and an open position. The fork bolt may be disposed relative to the striker such that it engages the striker in the primary latched position and in the secondary latched position. A primary detent lever may be positioned for selective engagement with the fork bolt and may be configured to rotate between a detent latched position, a secondary detent position, and a detent release position. A secondary detent lever may be positioned for selective engagement with the fork bolt and may be interactively coupled to the primary detent lever. The secondary detent lever may be configured to rotate between an engaged position and a disengaged position. The primary detent lever in the detent latched position, may engage and retain the fork bolt in the primary latched position. Upon a first rotation of the primary detent lever to the secondary detent position the primary detent lever may disengage the fork bolt which rotates to the secondary latched position and into retaining engagement with the secondary detent lever. Upon a second rotation of the primary detent lever to the detent release position, the primary detent lever may interact with the secondary detent lever to rotate it to the disengaged position and disengage it from the fork bolt which then rotates to the open position.

Variation 2 may include a product according to variation 1 including a power transfer stud through which the primary detent lever interacts with the secondary detent lever.

Variation 3 may include a product according to variation 1 or 2 with a cable connected to the primary detent lever. The second rotation of the primary detent lever, causing the secondary detent lever to rotate releasing the fork bolt to the open position only after the first rotation of the primary detent lever followed by a release of the cable to a relaxed condition.

Variation 4 may include a product according to variation 3 wherein when the cable is released to a relaxed condition, the power transfer stud is configured to translate along a foot surface of the secondary detent lever to an active position that enables the primary detent lever to rotate the secondary detent lever.

Variation 5 may include a product according to variation 4 including a fork bolt follower lever having a slot within which the power transfer stud may be positioned. When the cable is released to the relaxed condition, a spring may urge the fork bolt follower lever to rotate, moving the power transfer stud to the active position.

Variation 6 may include a product according to variation 5 wherein the fork bolt follower lever includes an arm with a cam follower that engages a cam surface of the fork bolt when in or near the primary latched position.

Variation 7 may include a product according to variation 6 wherein the cam follower engages a detent of the fork bolt when the power transfer stud is in the active position.

Variation 8 may include a product according to variation 7 wherein the cam surface of the fork bolt may be configured to slide along a first surface of the secondary detent lever, a second surface of the primary detent lever and the cam follower when the striker moves the fork bolt to the primary latched position.

Variation 9 may include a product according to any of variations 2-8 wherein the primary detent lever includes a slot within which the power transfer stud is positioned.

Variation 10 may include a latch that may have a plate with a fork bolt rotatably mounted on the plate in a first plane. A primary detent lever may be rotatably mounted on the plate and disposed in the first plane. The primary detent lever may selectively engage the fork bolt and may be configured to hold the fork bolt in a primary latched position. A secondary detent lever may have an offset section with a leg on a first side of the offset section disposed in a second plane and an arm on a second side of the offset section disposed in the first plane. The secondary detent lever may be configured to engage the fork bolt and to hold the fork bolt in a secondary latched position.

Variation 11 may include a latch according to variation 10 having a power transfer stud through which the primary detent lever interacts with the secondary detent lever.

Variation 12 may include a latch according to variation 11 with a cable connected to the primary detent lever. Rotation of the primary detent lever by the cable may move the power transfer stud to cause the secondary detent lever to rotate releasing the fork bolt to an open position only after the primary detent lever releases the fork bolt from the primary latched position followed by a release of the cable to a relaxed condition.

Variation 13 may include a latch according to variation 12 such that when the cable is released to the relaxed condition the power transfer stud is configured to translate along a foot surface of the secondary detent lever to an active position that enables the primary detent lever to rotate the secondary detent lever.

Variation 14 may include a latch according to variation 13 with a fork bolt follower lever including a slot within which the power transfer stud may be positioned. When the cable is released to the relaxed condition a spring urges the fork bolt follower lever to rotate moving the power transfer stud to the active position.

Variation 15 may include a latch according to variation 14 wherein the fork bolt follower lever may include an arm with a cam follower that engages a cam surface of the fork bolt when in or near the primary latched position.

Variation 16 may include a latch according to variation 15 wherein the cam follower engages a detent of the fork bolt when the power transfer stud is in the active position.

Variation 17 may include a latch according to variation 15 or 16 wherein the cam surface of the fork bolt slides along a surface of the secondary detent lever, a surface of the primary detent lever and the cam follower when a striker moves the fork bolt to the primary latched position.

Variation 18 may include a latch according to any of variations 11-18 wherein the primary detent lever includes an opening within which the power transfer stud may be positioned.

Variation 19 may include a latch for releasing the striker of a closure after two successive pulls of a cable and may include a fork bolt, a primary detent lever and a secondary detent lever. The fork bolt may be held in a primary latched position by the primary detent lever and the fork bolt may be held in the secondary latched position by the secondary detent lever. The fork bolt may be configured to hold the striker in a primary latched position and to release the striker from the primary latched position to a secondary latched position upon a first pull of the cable. The fork bolt may be configured to release the striker from the secondary latched position to an open position upon a second pull on the cable when preceded by a release of the cable following the first pull on the cable.

Variation 20 may include a latch according to variation 19 may include a fork bolt follower lever having a slot. A power transfer stud may be positioned in the slot and may be engageable between the primary detent lever and the secondary detent lever. Release of the cable to the relaxed condition may allow the fork bolt follower lever to rotate moving the power transfer stud to an active position that allows the primary detent lever to rotate the secondary detent lever upon the second pull on the cable.

The above description of select variations within the scope of the invention is merely illustrative in nature and, thus, variations or variants thereof are not to be regarded as a departure from the spirit and scope of the invention.

What is claimed is:

1. A product for latching a closure comprising: a striker connected to the closure; a fork bolt configured to rotate between a primary latched position, a secondary latched position and an open position, and being disposed relative to the striker such that it engages the striker in the primary latched position and in the secondary latched position; a primary detent lever positioned for selective engagement with the fork bolt and configured to rotate between a detent latched position, a secondary detent position, and a detent release position; and a secondary detent lever positioned for selective engagement with the fork bolt and interactively coupled to the primary detent lever, the secondary detent lever being configured to rotate between an engaged position and a disengaged position; wherein the primary detent lever, in the detent latched position, engages and retains the fork bolt in the primary latched position, and upon a first rotation of the primary detent lever to the secondary detent position the primary detent lever disengages the fork bolt which rotates to the secondary latched position and into retaining engagement with the secondary detent lever, and upon a second rotation of the primary detent lever to the detent release position, the primary detent lever interacts with the secondary detent lever to rotate it to the disengaged position and disengage it from the fork bolt which then rotates to the open position.

2. The product according to claim 1 further comprising a power transfer stud through which the primary detent lever interacts with the secondary detent lever.

3. The product according to claim 2 further comprising a cable connected to the primary detent lever, wherein the second rotation of the primary detent lever rotates the secondary detent lever, releasing the fork bolt to the open position, only after the first rotation of the primary detent lever is followed by a release of the cable to a relaxed condition.

4. The product according to claim 3 wherein when the cable is released to the relaxed condition, the power transfer stud is configured to translate along a foot surface of the secondary detent lever to an active position that enables the primary detent lever to rotate the secondary detent lever.

5. The product according to claim 4 further comprising a fork bolt follower lever, and a spring engaging the fork bolt follower lever; the fork bolt follower lever including a slot within which the power transfer stud is positioned; and wherein when the cable is released to the relaxed condition, the spring urges the fork bolt follower lever to rotate, moving the power transfer stud to the active position.

6. The product according to claim 5 wherein the fork bolt follower lever includes an arm with a cam follower and wherein the fork bolt includes a cam surface; wherein the cam follower engages the cam surface when the fork bolt is in or near the primary latched position.

7. The product according to claim 6 wherein the fork bolt includes a detent and the cam follower engages the detent when the power transfer stud is in the active position.

8. The product according to claim 7 wherein the cam surface is configured to slide along each of: a first surface of the secondary detent lever; a second surface of the primary detent lever; and the cam follower, when the striker moves the fork bolt to the primary latched position.

9. The product according to claim 8 wherein the primary detent lever includes a slot within which the power transfer stud is positioned.

10. A latch comprising: a plate; a fork bolt rotatably mounted on the plate in a first plane; a primary detent lever rotatably mounted on the plate, the primary detent lever disposed in the first plane and the primary detent lever selectively engaging the fork bolt, and the primary detent lever configured to hold the fork bolt in a primary latched position; and a secondary detent lever having an offset section with a leg disposed on a first side of the offset section, the leg disposed in a second plane, and the secondary detent lever having an arm disposed on a second side of the offset section, the arm disposed in the first plane and the arm configured to engage the fork bolt to hold the fork bolt in a secondary latched position.

11. The latch according to claim 10 further comprising a power transfer stud through which the primary detent lever interacts with the secondary detent lever.

12. The latch according to claim 11 further comprising a cable connected to the primary detent lever, wherein rotation of the primary detent lever by the cable, moves the power transfer stud to cause the secondary detent lever to rotate, the secondary detent lever releasing the fork bolt to an open position only after the primary detent lever has released the fork bolt from the primary latched position followed by a release of the cable to a relaxed condition.

13. The latch according to claim 12 wherein when the cable is released to the relaxed condition, the power transfer stud is configured to translate along a foot surface of the secondary detent lever to an active position that enables the primary detent lever to rotate the secondary detent lever.

14. The latch according to claim 13 further comprising a fork bolt follower lever and a spring engaging the fork bolt follower lever, the fork bolt follower lever including a slot, with the power transfer stud positioned in the slot, wherein when the cable is released to the relaxed condition, the spring urges the fork bolt follower lever to rotate, moving the power transfer stud to the active position.

15. The latch according to claim 14 wherein the fork bolt follower lever includes an arm with a cam follower, and wherein the fork bolt includes a cam surface; wherein the cam follower engages the cam surface when the fork bolt is in or near the primary latched position.

16. The latch according to claim 15 wherein the bolt includes a detent and the cam follower engages the detent when the power transfer stud is in the active position.

17. The latch according to claim 16 wherein the cam surface slides along each of: a first surface of the secondary detent lever; a second surface of the primary detent lever; and the cam follower, when a striker moves the fork bolt to the primary latched position.

18. The latch according to claim 17 wherein the primary detent lever includes an opening within which the power transfer stud is positioned.

19. A latch for releasing the striker of a closure after two successive pulls of a cable comprising: a fork bolt; a primary detent lever; a secondary detent lever; wherein the fork bolt is held in a primary latched position by the primary detent lever and the fork bolt is held in a secondary latched position by the secondary detent lever; the fork bolt configured to hold the striker in the primary latched position and the fork bolt configured to release the striker from the primary latched position to the secondary latched position upon a first pull of the cable; and the fork bolt configured to release the striker from the secondary latched position to an open position upon a second pull on the cable when preceded by a release of the cable following the first pull on the cable.

20. The latch according to claim 19 further comprising a fork bolt follower lever having a slot; a power transfer stud positioned in the slot; and the power transfer stud interacting between the primary detent lever and the secondary detent lever, wherein the release of the cable to the relaxed condition allows the fork bolt follower lever to rotate, moving the power transfer stud to an active position that allows the primary detent lever to rotate the secondary detent lever upon the second pull on the cable.
